(19) United States
(12) Patent Application Publication
(10) Pub. No.: US 2010/0281917 A1
(43) Pub. Date: Nov. 11, 2010

(54) Apparatus and Method for Condensing Contaminants for a Cryogenic System

(76) Inventor: Alexander LEVIN, Binyamina (IL)

Correspondence Address: DR. D. GRAESER LTD., 9003 FLORIN WAY, UPPER MARLBORO, MD, 20772, US

(21) Appl. No.: 12/611,938

(22) Filed: Nov. 4, 2009

Related U.S. Application Data
(60) Provisional application No. 61/111,355, filed on Nov. 5, 2008.

(51) Int. Cl. F25J 3/00; B01D 9/00

(52) U.S. Cl. 62/640; 62/123

(57) ABSTRACT

A system for removing contaminants from a gas, preferably through condensation and adsorption, followed by liquefaction of the gas.

This application claims priority from U.S. Provisional Application No. 61/111,355, filed on Nov. 5, 2008, which is hereby incorporated by reference as if fully set forth herein.

### FIELD OF THE INVENTION

The present invention relates to an apparatus and method for preventing ingress of contaminants into a liquid cryogen, and in particular, such an apparatus and method for removing such contaminants through condensation of gaseous cryogen.

### BACKGROUND OF THE INVENTION

There is a constantly growing demand for small-scale gas liquefaction systems, which can supply to a consumer liquid air, liquid oxygen or liquid nitrogen in the range of some liters per day.

Such systems can be widely applied in medicine (operation of cryosurgical equipment in medical offices, supply of breathing oxygen to persons requiring oxygen therapy in their homes and so forth), in biological and medical laboratories and in electronics (for example, for cooling infrared detectors).

The process of liquefaction of the ambient air or one of its components can be provided by application of small Stirling machines or Gifford-McMahon refrigerators with proper cooling capacity in the required range of the cryogenic temperatures. It is possible to use as well small size cryogenic refrigerators operating on the base of Joule-Thomson principle.

Such small-scale systems are described in U.S. Pat. Nos. 6,698,423, 6,212,904, 7,213,400, 7,318,327 and 7,165,422 and US Patent Application No. 20050274142.

These references teach incorporation of a unit intended to remove preliminary readily-condensing contaminants such as water vapors, carbon dioxide and hydrocarbons from the feed ambient air in order to prevent blockade of the system by these frozen readily-condensing contaminants, although not necessarily on a large scale (such as for example tens of liters per day of air).

Furthermore, the above references teach complicated and difficult solutions to the above problems.

### SUMMARY OF THE INVENTION

The background art does not teach or suggest a suitable, simple, efficient and inexpensive apparatus or method for removing contaminants, particularly gaseous contaminants, from a gaseous cryogen before its liquefaction.

The present invention overcomes these drawbacks of the background art by providing a system for removing contaminants from a gas, preferably through condensation and absorption, with liquefaction of the gas.

According to some embodiments, the present invention features a separator unit, for removing readily-condensing contaminants such as water vapors, carbon dioxide and hydrocarbons from the ambient feed air, for example and without limitation, to avoid damage such as clogging in a gas liquefaction system by these frozen readily-condensing contaminants. Preferably, the separator unit is adapted for use in a small scale system.

Total removal of readily-condensing contaminants, or at least removal of a significant portion of the contaminants, is preferably performed in a plurality of stages: preliminary cooling of the feed air to temperature above and in vicinity of 0° C. with removal of significant fraction of water vapors and VOC (volatile organic compounds); removal of the most fraction of water vapors by adsorption or chemisorptions; and freezing the remaining readily-condensing contaminants at a suitable temperature, which lies in the temperature range of liquid nitrogen.

The remaining, frozen, readily-condensing contaminants are preferably repeatedly, and optionally and more preferably constantly, scraped from a heat exchanging surface of the final freezing chamber and periodically removed from a final freezing chamber by thawing and blowing off.

The process for freezing the remaining readily-condensing contaminants is accompanied with complete or partial liquefaction of air in the final freezing chamber; the obtained liquid fraction is then preferably filtered through a filter in order to collect particles of frozen remained readily-condensing contaminants, more preferably for its discharge, for example optionally into a Dewar flask.

A significant part of water vapors in the main (delivery) line for the gaseous cryogen may optionally be preliminary removed by a thermoelectric cooling unit, by cooling the gaseous cryogen to temperature above 0° C. The obtained condensate is preferably removed from this thermoelectric unit by a miniature condensate tapper.

Further removal of a significant fraction of water vapors is optionally and preferably performed by a second unit, more preferably with an adsorbent, for example and without limitation, silicagel or zeolite, which is optionally and most preferably contained in two or three chambers operating alternatively.

The final removal of the remaining readily-condensing contaminants is executed in parallel with complete or partial liquefaction of the air.

The obtained liquid air or liquid air with oxygen is then collected, for example optionally in a Dewar flask.

Known methods in the background art for removing contaminants, particularly gaseous contaminants, from a liquid cryogen, rely upon the application of a cumbersome method that uses PSA: pressure swing absorption. By contrast, the embodiments of the present invention as described herein do not rely upon PSA.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice.

FIG. 1 is a block-diagram of an illustrative, general system of gas liquefaction and purification according to at least some embodiments of the present invention;

FIG. 2 is a longitudinal cross-section of a heat exchanging chamber operative for first stage removal of readily-condensing contaminants by cooling with a thermoelectric element according to at least some embodiments of the present invention;

FIG. 3 is a longitudinal cross-section of an adsorbing unit operative for removal of readily-condensing contaminants, such as for example water vapors, by adsorption material according to at least some embodiments of the present invention;

FIG. 4 is an axial cross-section of a freezing-liquefaction chamber operative for final removal of readily-condensing contaminants according to at least some embodiments of the present invention; and

FIG. 5 is a flowchart of an exemplary method for operation of at least some embodiments of the present invention.

### DETAILED DESCRIPTION OF PREFERRED EMBODIMENTS

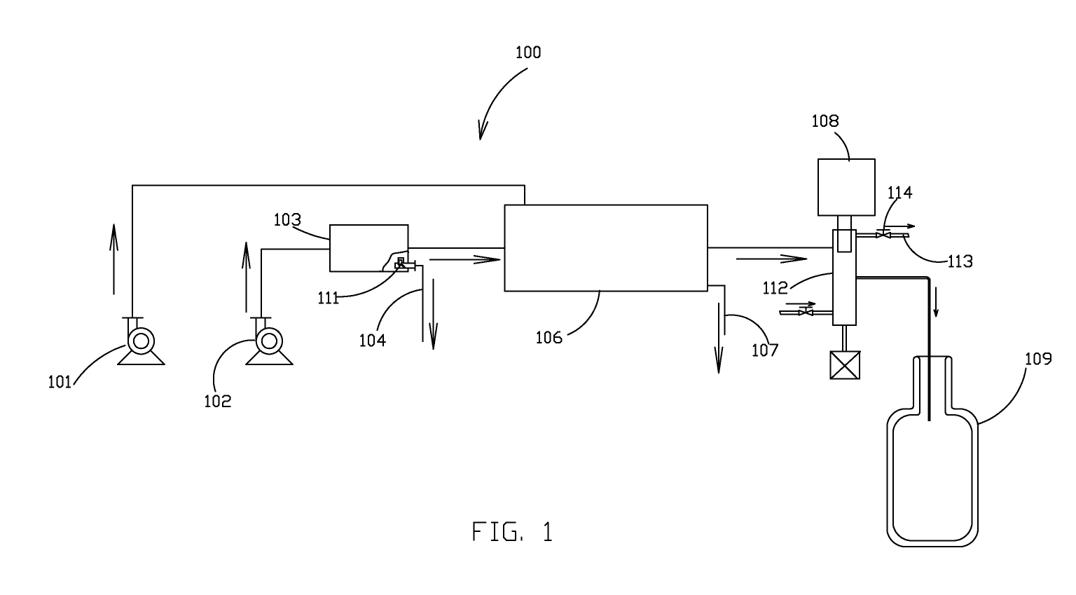

FIG. 1 shows a block-diagram of an illustrative, general system of gas liquefaction and purification according to at least some embodiments of the present invention.

A system 100 of gas liquefaction and purification, comprises a main air blower 102 and optionally and preferably an auxiliary air blower 101, operative for blowing-off readily-condensing contaminants.

The gas (air) to be liquefied enters the main air blower 102 and from the main air blower 102 passes through a heat exchanging chamber 103, which removes a significant fraction of water vapor contained in the air through cooling, and which may for example optionally comprise a thermoelectric cooler. The obtained condensate is drained via a condensate tapper 111, which is preferably small or miniature, by a condensate line 104. Condensate tapper 111 is connected to or integrally formed with the heat exchanging chamber 103.

The gas (air) from heat exchanging chamber 103 is preferably passed through an absorption unit 106, which further reduces concentration of water vapors in the air to a level which is preferably of the same order of magnitude as the concentration of carbon dioxide in the air.

This reduction is preferably executed by at least one, and preferably a plurality of, cartridges present within the absorption unit 106 (not shown). The cartridges optionally and preferably feature an adsorbent (for example, silicagel). The cartridges more preferably alternate in operation: for example, at least one cartridge adsorbs water vapors while at least one other cartridge is being regenerated, for example by receiving air from the auxiliary air blower 101, to remove the absorbed vapors. Such air is preferably expelled via line 107.

The dried air, after passing through absorption unit 106, is preferably introduced into a freezing chamber 112 for final freezing and condensation of water vapors, carbon dioxide and other readily-condensing contaminants. Freezing chamber 112 preferably features a cryocooler (not shown) of any suitable type, including but not limited to Stirling, Gifford-McMahon or Joule-Thomson cryocoolers.

The purified, liquefied gas preferably passes from the freezing chamber 112 to a Dewar flask 109, as a non-limiting example of a container for receiving the obtained liquefied gas or optionally liquefied gas enriched with oxygen. The liquefied gas preferably passes via the filter (not shown) of the freezing chamber 112 before accumulating in Dewar flask 109.

The freezing chamber 112 preferably contains a scraper (not shown) for permanent removal of frozen readily-condensing contaminants (mainly water vapors and carbon dioxide) from the freezing surface and a filter (not shown) which prevents ingress of frozen readily-condensing contaminants into the Dewar flask 109.

Line 113 with valve 114 optionally provides periodical or permanent communication of the internal space of the freezing chamber 112 with a vacuum pump (not shown), for removal of any accumulated contaminants.

In operation, as described above, the gas to be purified and liquefied (for example the gaseous fraction of a cryogen and/or a gas which is to be converted to a cryogen) first enters through main air blower 102 and then passes through the heat exchanging chamber 103, which removes a significant fraction of water vapor contained in the gas through cooling. The gas then pass through adsorption unit 106, which further reduces concentration of water vapors in the air to a level which is preferably of the same order of magnitude as the concentration of carbon dioxide in the air, for example through the operation of cartridges as described above.

Further removal of contaminants and freezing (and liquefaction) of the gas occurs in freezing chamber 112, after which the liquefied, purified gas preferably passes to a container such as Dewar flask 109 for example.

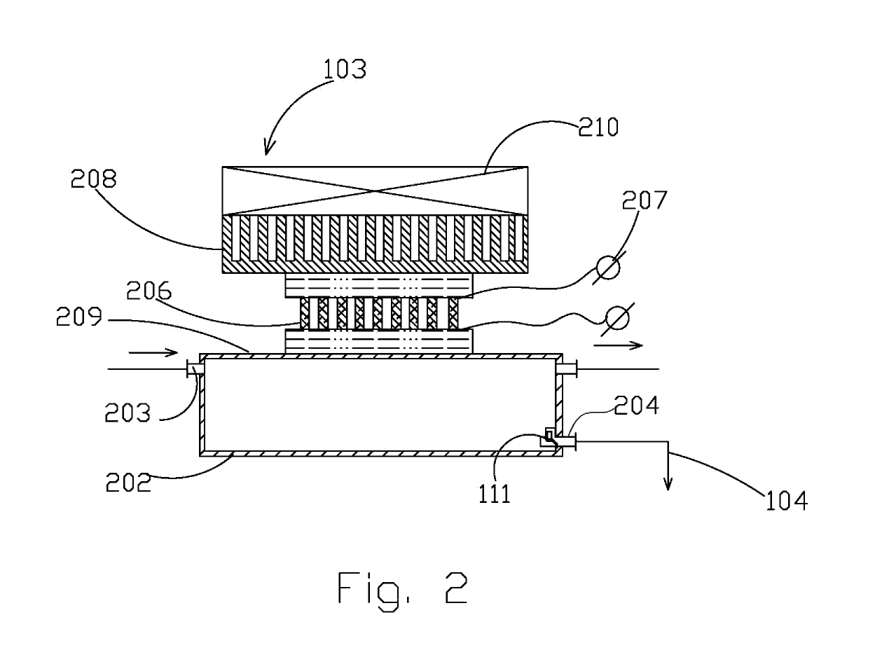

FIG. 2 is an axial cross-section of an exemplary embodiment of the heat exchanging chamber 103 for removal of readily-condensing contaminants, preferably by cooling with a thermoelectric element.

The heat exchanging chamber 103 preferably comprises an upper heat exchanging plate 209 with a thermoelectric (Peltier) element 206 installed on it. This upper heat exchanging plate 209 covers a container 202. A heat sink radiator 208 is installed on the hot side of the thermoelectric (Peltier) element 206. A fan 210 preferably reduces the temperature of the heat sink radiator 208 for example with ambient air, although of course active chilling could also be used. Electrical current (DC) is supplied to the thermoelectric (Peltier) element 206 through contacts 207. An inlet connection 203 of the container 202 receives the gas to be purified; an outlet connection 204 provides removal of the chilled air to the adsorption unit 106 (not shown, see FIG. 1).

Obtained condensate, which is accumulated in container 202, is drained via the previously described condensate tapper 111 and condensate line 104.

As described herein, gas is received from main air blower 102 (not shown, see FIG. 1) and then enters container 202. The gas is cooled in container 202 by upper heat exchanging plate 209, which in turn is cooled by thermoelectric (Peltier) element 206. Thermoelectric (Peltier) element 206 is in turn cooled by heat sink radiator 208.

The cooled gas preferably exits container 202 through outlet 204 and passes to adsorbing unit 106 (not shown, see FIG. 1).

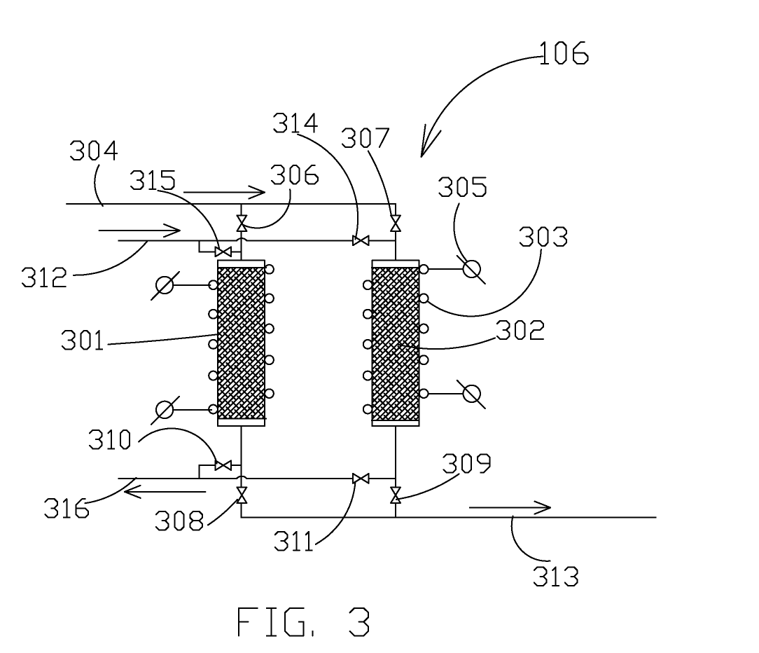

FIG. 3 is a radial cross-section of an exemplary adsorbing unit according to at least some embodiments of the present invention, for removal of readily-condensing contaminants, for example water vapors, by absorption material.

The adsorbing unit 106 preferably comprises at least one and more preferably a plurality of cartridges 301, of which two are shown for the purpose of description only and without intending to be limiting. Each cartridge 301 preferably features an adsorbent material 302 with high adsorption ability of water vapors.

The gas to be dried is fed into cartridges 301 via a line 304 from heat exchanging chamber 103 (not shown, see FIGS. 1 and 2). Line 304 preferably features control valves 306 and 307. The gas to be dried then exits cartridges 301 via line 313, to freezing chamber 112 (not shown, see FIG. 1). Line 313 preferably features control valves 309 and 308.

Cartridges 301 preferably also feature outer heating spirals 303 to regenerate the absorbent material 302, through heating. Electrical heating power is preferably supplied through contacts 305 to heat outer heating spirals 303. Regeneration preferably occurs through a combination of heating each cartridge 301 and passing drying air through each cartridge 301. Optionally and preferably, the cartridges 301 are not all regenerated simultaneously.

The drying air for regenerating adsorbent material 302 is preferably supplied into cartridges 301 via line 312, preferably featuring control valves 314 and 315. The drying air then preferably exits cartridges 301 via line 316, featuring control valves 310 and 311.

In operation, the gas to be dried is fed into cartridges 301 through line 304 from heat exchanging chamber 103 (not shown, see FIGS. 1 and 2). The gas to be dried then exits cartridges 301 through line 313, to freezing chamber 112 (not shown, see FIG. 1).

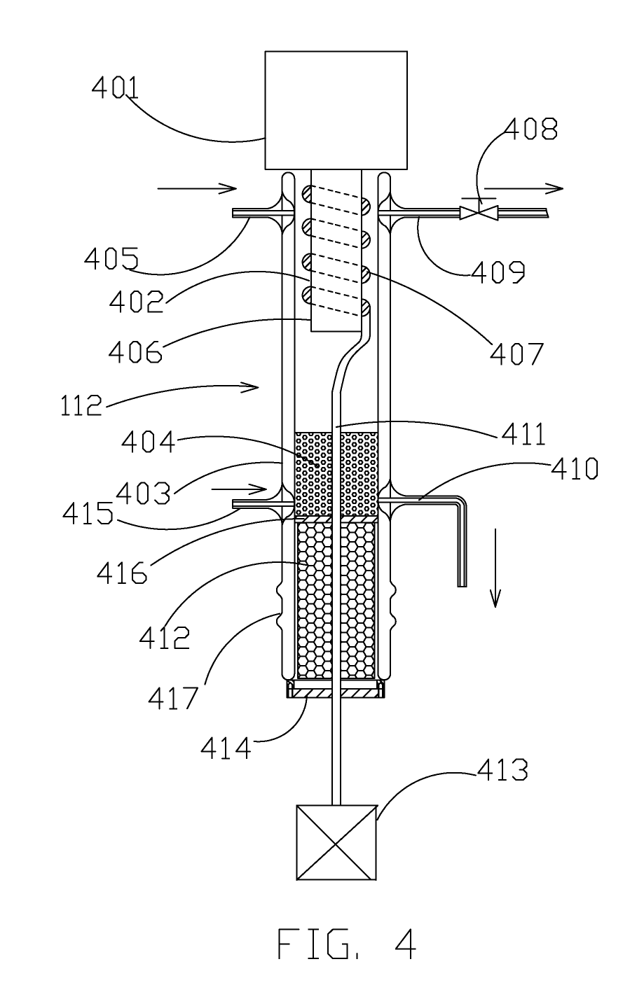

FIG. 4 is an axial cross-section of an exemplary freezing chamber 112 according to at least some embodiments of the present invention, for final removal of readily-condensing contaminants.

Freezing chamber 112 preferably features a cryocooler 401, which is connected to a freezing cylindrical member 402. Cylindrical member 402 is situated in a freezing-liquefaction chamber 403 with cylindrical walls that preferably feature vacuum insulation. Freezing-liquefaction chamber 403 preferably features a thermo-insulation member 412 in the lower section. The lower edge of the freezing-liquefaction chamber 403 is preferably closed by disk 414.

Freezing-liquefaction chamber 403 also preferably features a bellows section 417 for neutralizing or at least reducing thermo-mechanical tension created as the result of high temperature difference between the internal and outer walls of the freezing-liquefaction chamber 403.

The freezing-liquefaction chamber 403 is provided with two inlet connections 405 and 415 for receiving the dried gas from the adsorbing unit 106 (not shown, see FIGS. 1 and 3). The purified, liquefied gas is then ejected through two outlet connections 409 and 410. Outlet connection 409 is preferably fluidly communicating with a vacuum pump (not shown) via a control valve 408, for regeneration. Outlet connection 410 preferably discharges the liquefied gas or liquefied gas enriched with oxygen content into a Dewar flask 109 (not shown, see FIG. 1).

For regeneration, freezing-liquefaction chamber 403 is preferably treated with a combination of scraping and regenerating air. Inlet connections 405 and 415 preferably receive the regenerating air. A scraper 407 situated on the cylindrical surface of the freezing cylindrical member 402 is joined by axle 411 to driver 413 (a combination of a motor with a reductor), thereby supporting revolution of the scraper 407. Such revolution scrapes, and hence cleans, the cylindrical surface of the freezing cylindrical member 402, by removing the frozen readily-condensing contaminants, especially, from any remaining water vapors and carbon dioxide. Debris of the frozen readily-condensing contaminants are accumulated in the internal space of the freezing-liquefaction chamber 403. A filter 404, supported by disk 416, separates the debris of the frozen readily-condensing contaminants and the liquefied gas or the liquefied gas enriched with liquid oxygen.

The control valve 408 is open periodically when the freezing process of cryocooler 401 is stopped, and debris of the frozen readily-condensing contaminants are melted and evaporated by warm dry air. The debris is then expelled through outlet connection 409 and filter 404.

For liquefaction of the gas, such as air for example, the freezing cylindrical member 402 is preferably maintained at temperatures lower than the freezing temperature of the gas (in case of air, this temperature is preferably lower than −195° C.). In order to obtain liquid gas enriched with oxygen, the temperature of the freezing cylindrical member 402 is preferably higher, but lower than temperature of liquefaction of oxygen at atmospheric pressure, which is −183° C.

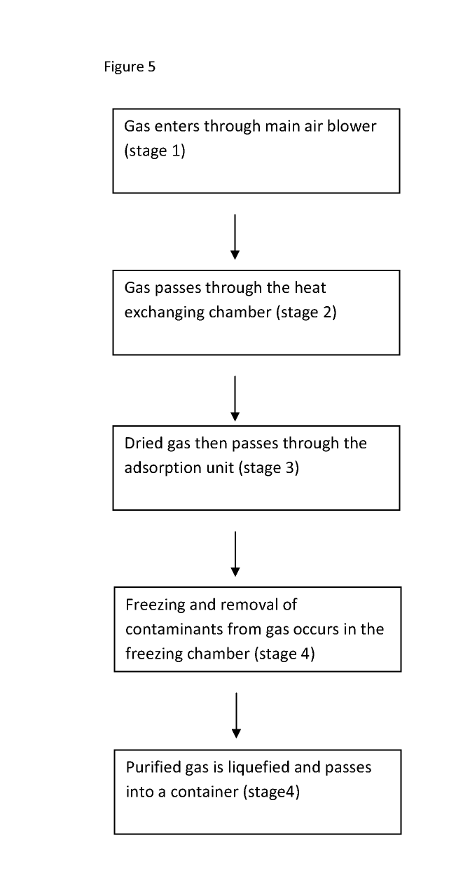

FIG. 5 is a flowchart of an exemplary method according to at least some embodiments of the present invention. As shown, in stage 1, the gas to be purified and liquefied (for example the gaseous fraction of a cryogen and/or a gas which is to be converted to a cryogen and/or air or another gas to be liquefied) first enters through main air blower. In stage 2, the gas passes through the heat exchanging chamber, which removes a significant fraction of water vapor contained in the gas through cooling. The dried gas then passes through the adsorption unit in stage 3, which further reduces concentration of water vapors in the air to a level which is preferably of the same order of magnitude as the concentration of carbon dioxide in the air.

Further removal of contaminants and liquefaction of the gas occurs in the freezing chamber, in stage 4. In stage 5, the liquefied, purified gas preferably passes to a container such as a Dewar flask for example.

While the invention has been described with respect to a limited number of embodiments, it will be appreciated that many variations, modifications and other applications of the invention may be made.

1. A system of gas liquefaction comprising:
a heat exchanging chamber for receiving the gas and heating the gas to remove water vapors for forming dried gas;
a freezing chamber for receiving said dried gas and for further cooling said dried gas to remove readily-condensing contaminants, and to liquefy said dried gas to form liquefied gas; and
a container for receiving said liquefied gas.

2. The system of claim 1, wherein said heat exchanging chamber comprises a thermoelectric unit for cooling the gas.

3. The system of claim 1, further comprising an adsorption unit for receiving said dried gas from said heat exchanging chamber and for further reducing vapors of contaminants in said dried gas.

4. The system of claim 3, wherein the gas is air.

5. The system of claim 4, wherein said vapors are reduced in the adsorption unit to a level which is of the same order of magnitude as the concentration of carbon dioxide in the air.

6. The system of claim 1, wherein the freezing chamber comprises a cryocooler with a freezing cylindrical member for freezing said gas, which is situated in a freezing-liquefaction chamber for receiving said dried gas for being frozen.

7. The system of claim 6, wherein the freezing chamber comprises cylindrical walls with vacuum insulation.

8. The system of claim 7, wherein said freezing chamber comprises a bellows section for reduction of thermo-mechanical tension.

9. The system of claim 7, wherein said freezing chamber comprises a scraper on the cylindrical surface of the freezing cylindrical member.

10. The system of claim 9, wherein debris of the frozen readily-condensing contaminants removed by the scraper accumulate in the internal space of the freezing chamber, and are removed through blowing regenerating air.

11. The system of claim 10, wherein the lower internal section of the freezing chamber comprises a thermo-insulation member.

12. The system of claim 1, adapted for a small-scale system.
